(19) United States
(12) Patent Application Publication
(10) Pub. No.: US 2005/0277314 A1
(43) Pub. Date: Dec. 15, 2005

(54) CONDUCTIVE CLIP

(75) Inventor: Yasuhiko Inoue, Toyonaka (JP)

Correspondence Address: KANESAKA BERNER AND PARTNERS LLP, SUITE 300, 1700 DIAGONAL RD, ALEXANDRIA, VA, 22314-2848, US

(73) Assignee: NIFCO INC., Yokohama (JP)

(21) Appl. No.: 11/148,294

(22) Filed: Jun. 9, 2005

(30) Foreign Application Priority Data
Jun. 15, 2004 (JP) 2004-176774

(51) Int. Cl. H01R 13/648

(52) U.S. Cl. 439/92

(57) ABSTRACT

A conductive clip includes a hollow cylindrical member having a flange at one edge thereof in an axial direction and an opening communicating in a radial direction at an intermediate portion thereof in the axial direction, and a conductive member having an axial elastic force generating piece facing an inner surface of the large diameter flange and a radial elastic force generating piece passing through the opening inwardly or outwardly. The conductive member is fitted to the hollow cylindrical member to be relatively movable in the axial direction. When the hollow cylindrical member moves outwardly relative to the conductive member, the radial elastic force generating piece is pushed by an inner edge of the opening in the radial direction, so that a free end of the radial elastic force generating piece moves outwardly or inwardly in the radial direction.

### BACKGROUND OF THE INVENTION AND RELATED ART STATEMENT

The present invention relates to a conductive clip for fixing a printed circuit board to a metallic chassis and connecting an earth pattern formed on the printed circuit board to the metallic chassis.

Conventionally, a printed circuit board is fastened with a metallic fastening screw. An earth pattern of the printed circuit board is formed around an insertion hole, and a head of the metallic screw contacts the earth pattern, thereby connecting the circuit board to a chassis (chassis earth). However, workability of fastening a screw is relatively low. Patent Reference 1 has disclosed a fixing device having an engaging wing portion made of a highly conductive resin, so that earth connection is completed with one touch operation.

Patent Reference 1: Japanese Patent Publication (Kokai) NO. 2002-025646

In the fixing device disclosed in Patent Reference 1, the highly conductive resin has conductivity lower than that of metal, and relatively large creep deterioration. Accordingly, a contact pressure is not stable, and it is difficult to maintain sufficient conductivity for long time.

In view of the problems described above, an object of the present invention is to provide a conductive clip with steady long term conductivity capable of attaching with one touch operation.

Further objects and advantages of the invention will be apparent from the following description of the invention.

### SUMMARY OF THE INVENTION

In order to attain the objects described above, a conductive clip includes a hollow cylindrical member (cylindrical body) having a large diameter flange at one end thereof in an axial direction and an opening communicating in a radial direction at an intermediate portion thereof in the axial direction; and a conductive member having an axial elastic force generating piece facing an inner surface of the large diameter flange and a radial elastic force generating piece passing through the opening inwardly or outwardly. The conductive member is fitted to the hollow cylindrical member to be relatively movable in the axial direction. When the conductive member and the hollow cylindrical member move relatively in the axial direction, the radial elastic force generating piece is pushed by an inner edge of the opening in the radial direction, so that a free end of the radial elastic force generating piece moves outwardly or inwardly in the radial direction.

According to the present invention, the conductive clip may include each of the axial elastic force generating piece and the radial elastic force generating piece as a singular member. Further, a concave portion may be formed in a surface of the large diameter flange facing the axial elastic force generating piece for providing a space so that the axial elastic force generating piece is accommodated therein.

According to the present invention, the hollow cylindrical member is fitted into a convex portion or a concave portion formed in a chassis through a hole formed in a printed circuit board, so that the large diameter flange holds the printed circuit board not to come out, thereby attaching the printed circuit board to the chassis with one touch operation. At this time, the axial elastic force generating piece is placed between the flange and an earth pattern, and the radial elastic force generating piece abuts against an outer circumference surface of the convex portion of the chassis or an inner circumference surface of the concave portion of the chassis, thereby forming an earth circuit.

The radial elastic force generating piece is strongly held due to an axial force of the axial elastic force generating piece, thereby strongly fixing the conductive clip to the chassis. When only the hollow cylindrical member is pulled out in the axial direction, the radial elastic force generating piece is pushed against the inner edge of the opening in the axial direction, so that the radial elastic force generating piece moves away from the outer circumference surface of the convex portion of the chassis or the inner circumference surface of the concave portion of the chassis. Accordingly, it is possible to easily remove the printed circuit board from the chassis.

When the conductive clip may include each of the axial elastic force generating piece and the radial elastic force generating piece as a singular member, it is possible to reduce an amount of a material. Further, the concave portion may be formed in the surface of the large diameter flange facing the axial elastic force generating piece for providing a space so that the axial elastic force generating piece is accommodated therein. Accordingly, when the conductive clip is pushed in until the flange abuts against the printed circuit board, the axial elastic force generating piece does not generate a permanent deformation due to the space for the axial elastic force generating piece. Accordingly, it is possible to reduce creep deterioration, thereby obtaining an ability of repeating attachment and stable conductivity for long time.

### BRIEF DESCRIPTION OF THE DRAWINGS

FIG. 1 is a perspective view showing a conductive clip according to a first embodiment of the present invention;

FIG. 2 is a longitudinal sectional view showing the conductive clip in an attached state according to the first embodiment of the present invention;

FIG. 3 is a longitudinal sectional view showing the conductive clip in a removing state according to the first embodiment of the present invention;

FIG. 4 is a perspective view showing a modified example of a conductive member;

FIG. 5 is a longitudinal sectional view showing the conductive clip in a state that the conductive clip is pushed against a printed circuit board;

FIG. 6 is a longitudinal sectional view showing a conductive clip in an attached state according to a second embodiment of the present invention;

FIG. 7 is a longitudinal sectional view showing the conductive clip in the removing state according to of the second embodiment the present invention;

FIG. 8 is a perspective view showing a conductive member according to the second embodiment; and

FIG. 9 is a perspective view showing a modified example of the conductive member according to the second embodiment.

### DETAILED DESCRIPTION OF PREFERRED EMBODIMENT

Hereunder, embodiments of the present invention will be described with accompanying drawings.

First Embodiment

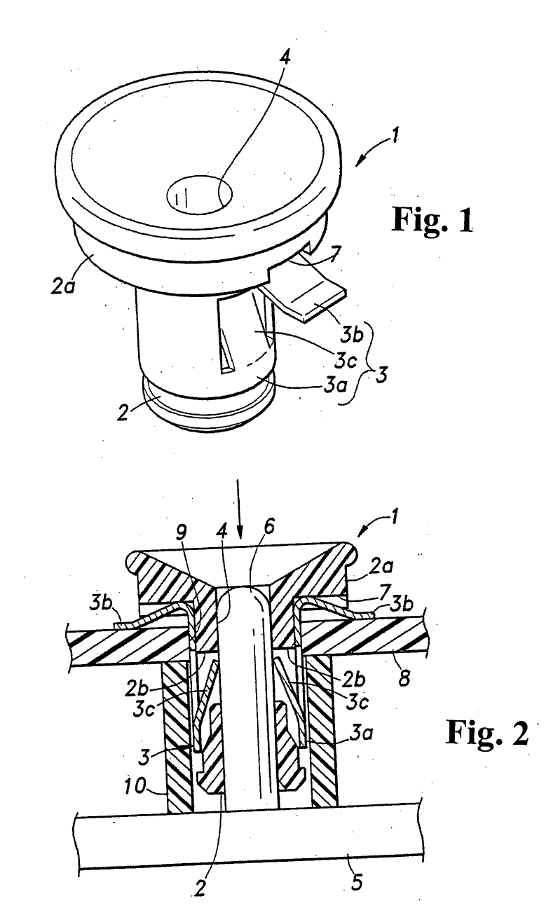

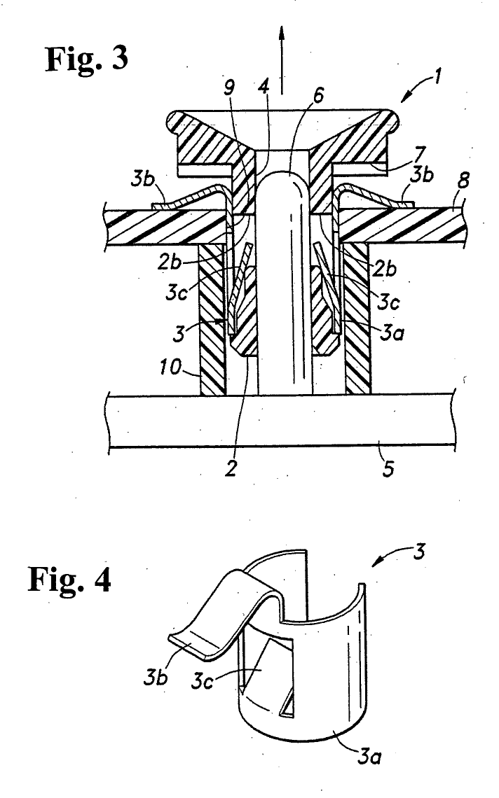

FIG. 1 to 3 are views showing a conductive clip according to a first embodiment of the present invention. A conductive clip 1 fixes a printed circuit board to a metal chassis, and includes a cylindrical body 2 made of a synthetic resin and a conductive member 3 made of metal. The cylindrical body 2 is formed of a synthetic resin with injection molding, and has a large diameter flange 2a at an end thereof. As shown in FIGS. 2 and 3, a stud pin 6 integrally provided on a chassis 5 is inserted into a through-hole 4 formed in the cylindrical body 2 at a center thereof along an axial direction. Concave portions 7 with a rectangular cross section are formed in a rear surface of the flange 2a along a radial direction. Two openings 2b are formed in the cylindrical body 2 at intermediate positions thereof in the axial direction. The openings 2b generally have a rectangle shape with a long side along the axial direction and penetrate in the radial direction along a diameter of the cylindrical body 2.

The conductive member 3 is formed of a thin plate made of beryllium copper having conductivity and elasticity. The conductive member 3 includes a main portion 3a with a cylindrical shape; two axial elastic force generating pieces 3b extending from an end of the main portion 3a in a radial direction; and two radial elastic force generating pieces 3c formed by cutting a part of the main portion 3a in an inverted U-shape and pushing free ends inwardly. In the conductive member 3, the main portion 3a is fitted onto an outer circumference of the cylindrical body 2, and the axial elastic force generating pieces 3c face the concave portions 7 of the flange 2a of the cylindrical body 2. Free ends of the radial elastic force generating pieces 3c are inserted obliquely and upwardly into the openings 2b formed in the cylindrical body 2 at intermediates portion thereof in the axial direction. Further, the free ends of the radial elastic force generating pieces 3c are inserted slightly into the through-hole 4 in a normal state.

The axial elastic force generating pieces 3b and the radial elastic force generating pieces 3c are preferably disposed at positions equally dividing a circumference of the main portion 3a in view of a force balance. As shown in FIG. 4, just each one of the axial elastic force generating piece 3b and the radial elastic force generating piece 3c may be formed on the main portion 3a with a C shape surrounding the outer circumference of the cylindrical body 2, thereby saving a material. The openings 2b of the cylindrical body 2 and the concave portions 7 correspond to the axial elastic force generating pieces 3b and the piece radial elastic force generating pieces 3c, respectively.

An insertion hole 9 of the conductive clip 1 is formed in a printed circuit board 8, and an earth pattern is formed on an upper surface of the printed circuit board 8 around the insertion hole 9 of the conductive clip 1 similar to a conventional one fixed with a screw (not shown).

When the printed circuit board 8 is fixed to the chassis 5, a collar 10 is loosely fitted on the stud pin 6 of the chassis 5. An end of the stud pin 6 is inserted into the insertion hole 9 of the conductive clip 1 for the printed circuit board 8. Then, the end of the stud pin 6 appearing at a center of the insertion hole 9 of the conductive clip 1 is fitted into the through-hole 4 formed in the cylindrical body 2 of the conductive clip 1. An end face of the cylindrical body 2 with a concave shape in the axial direction (an arrow direction) is pushed in with a finger.

The two axial elastic force generating pieces 3c formed on the conductive member 3 are inclined upwardly and obliquely toward inside. Accordingly, the free ends of the axial elastic force generating pieces 3c abut against the outer circumference surface of the stud 6, and the axial elastic force generating pieces 3c elastically deform outwardly in the radial direction, thereby easily attaching the conductive clip 1 to the stud pin 6. In this state, the axial elastic force generating pieces 3b contact the earth pattern on the upper surface of the printed circuit board 8, and the radial elastic force generating pieces 3c contact the outer circumference of the stud 6, thereby establishing chassis earth.

In this state, the axial elastic force generating pieces 3b elastically push the printed circuit board 8 downwardly, so that the main portion 3a is pushed upwardly with a reaction force. Due to the upward reaction force, the free ends of the radial elastic force generating pieces 3c are pressed inwardly against the outer circumference of the stud pin 6, so that the conductive clip 1 dose not become loose by vibration.

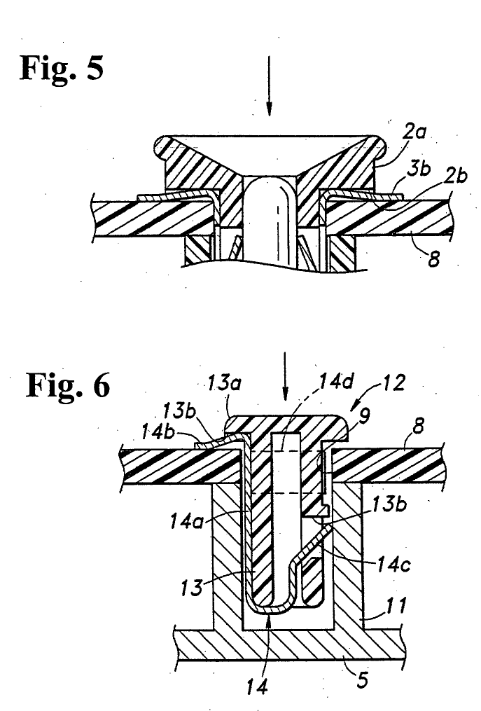

As shown in FIG. 5, when the cylindrical body 2 is pushed in completely until a rear surface of the flange 2a abuts against the surface of the printed circuit board 8, the axial elastic force generating pieces 3b are accommodated in the concave portions 7 formed in the rear surface of the flange 2a. That is, when the conductive clip 1 is pushed in completely, the axial elastic force generating pieces 3b deform and are accommodated in the spaces. Accordingly, the axial elastic force generating pieces 3b does not have permanent strain, and it is possible to maintain steady contact pressure for long time, thereby obtaining an ability of repeating attachment and stable conductivity.

When the conductive clip 1 is detached, as shown in FIG. 3, the large diameter flange 2a of the cylindrical 2 is pulled upwardly (an arrow direction). An lower edge of the opening 2b retaining the radial elastic force generating pieces 3c of the conductive member 3 abuts against inner surfaces of the radial elastic force generating pieces 3c, so that the radial elastic force generating pieces 3c are pushed outwardly. Accordingly, the free ends of the radial elastic force generating pieces 3c move away from the outer circumference surface of the stud pin 6, thereby easily detaching the conductive clip 1 from the stud pin 6. As described above, it is possible to easily repeat the attachment and detachment.

Second Embodiment

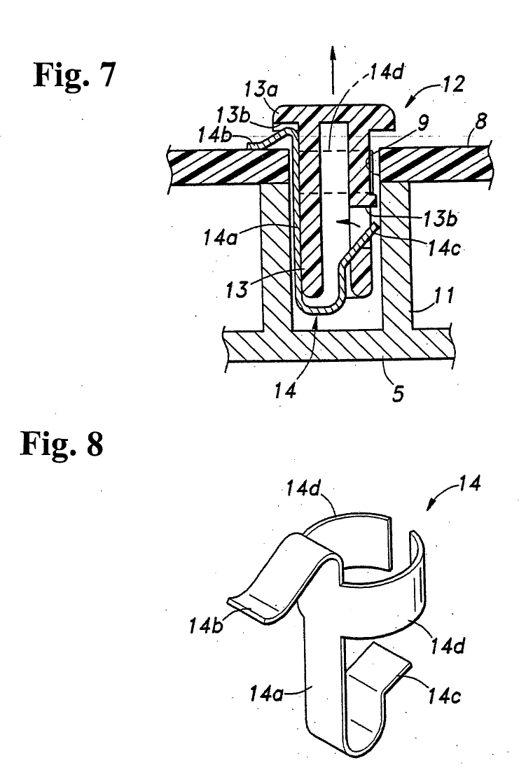

FIGS. 6 and 7 are views showing a conductive clip according to a second embodiment of the prevent invention. In the second embodiment, a conductive clip 12 is fitted into a tubular boss 11 provided on the chassis 5. Similar to the first embodiment, the conductive clip 12 is formed of a cylindrical body 13 made of a synthetic resin and a conductive member 14 made of metal.

The cylindrical body 13 is formed of a synthetic resin with injection molding. A large diameter flange 13a is formed at an end of the cylindrical body 13, and a hole 15 with a lower open end is formed at a center of the cylindrical body 13. An opening 13b with a rectangle shape is formed in the cylindrical body 13 at an intermediate portion thereof in an axial direction. Similar to the first embodiment above, a concave portion 16 is formed in a rear surface of the large diameter flange 13a along a radius line thereof.

As shown in FIG. 8, the conductive member 14 is formed of a beryllium copper plate with a J shape. The conductive member 14 includes an axial elastic force generating piece 14b extending outwardly from an end of an elongated axial portion 14a; a radial elastic force generating piece 14c extending obliquely and outwardly from the other end of the elongated axial portion 14a; and holding portions 14d with a curved shape extending toward both sides from a portion near a base portion of the axial elastic force generating piece 14b.

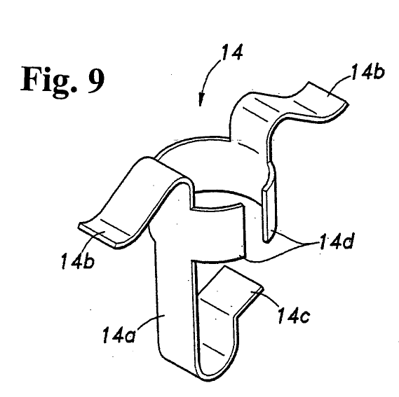

In the conductive member 14, the axial portion 14a is fitted onto an outer circumference of the cylindrical body 12 in an axial direction, and the holding portions 14d hold the outer circumference of the cylindrical body 12. The axial elastic force generating piece 14b faces the concave portion 16 formed in the rear surface of the large diameter flange 13a of the cylindrical body 12. The radial elastic force generating piece 14c is inserted upwardly into the blind hole 15 from a lower end thereof, so that a free end of the radial elastic force generating piece 14c projects obliquely and upwardly through the opening 13b formed in the cylindrical body 12 at the intermediate portion thereof in the axial direction. The free end of the radial elastic force generating piece 14c projects slightly from an outer circumference surface of the cylindrical body 13 in a normal state. As shown in FIG. 9, two axial elastic force generating pieces 14b may be provided to extend from the holding portions 14d in opposite directions.

In the second embodiment, the printed circuit board 8 is placed on an upper end surface of the tubular boss 11 formed on the chassis 5, and the conductive clip 12 is inserted into an inner circumference surface of the tubular boss 11 through the insertion hole 9 for the conductive clip 12 formed in the printed circuit board 8. The radial elastic force generating piece 14c is inclined obliquely and upwardly. When the free end of the radial elastic force generating piece 14c abuts against the inner circumference surface of the tubular boss 11, the radial elastic force generating piece 14c deforms inwardly, thereby easily inserting the conductive clip 12 into the inner circumference of the tubular boss 11. Similar to the first embodiment, when the conductive clip 12 is pushed in completely, the free end of the axial elastic force generating piece 14b is accommodated in the concave portion 16.

When the conductive clip 12 is detached, the large diameter flange 13a of the cylindrical body 13 is pulled upwardly. Accordingly, a lower end of the opening 13b of the cylindrical body 13 pushes the radial elastic force generating piece 14c to move away from the inner circumference surface of the tubular boss 11, thereby easily detaching the conductive clip 12.

In the embodiments of the present invention described above, the earth pattern of the printed circuit board is connected to the chassis. The invention is not limited to the earth pattern of the printed circuit board, and it is possible to connect a pressure terminal to an earth terminal.

The disclosure of Japanese Patent Application No. 2004-176774, filed on Jun. 15, 2004, is incorporated in the application.

While the invention has been explained with reference to the specific embodiments of the invention, the explanation is illustrative and the invention is limited only by the appended claims.

1. A conductive clip comprising:
a hollow cylindrical member having a flange at one axial end thereof, and an opening communicating in a radial direction at an axial intermediate portion thereof, and
a conductive member having an axial elastic force generating piece facing a rear surface of the flange and a radial elastic force generating piece passing through the opening inwardly or outwardly, said conductive member being attached to the hollow cylindrical member to be movable in an axial direction so that when the cylindrical member is moved away from the conductive member, the radial elastic force generating piece is pushed by an inner edge of the opening to move a free end of the radial elastic force generating piece outwardly or inwardly in the radial direction.

2. A conductive clip according to claim 1, wherein each of said axial elastic force generating piece and said radial elastic force generating piece includes one member, respectively.

3. A conductive clip according to claim 1, wherein said flange includes a concave portion at a surface facing the axial elastic force generating piece for accommodating the axial elastic force generating piece therein.

4. A conductive clip according to claim 1, wherein said hollow cylindrical member includes an axial hole therein, and said conductive member includes a main portion slidably disposed outside the cylindrical member.

5. A conductive clip according to claim 4, wherein said radial elastic force generating piece is inserted into the axial hole through the opening.

6. A conductive clip according to claim 4, wherein said radial elastic force generating piece is inserted into the axial hole from a lower end of the cylindrical member and projects outwardly through the opening.
